(19) United States
(12) Patent Application Publication
(10) Pub. No.: US 2009/0138104 A1
(43) Pub. Date: May 28, 2009

(54) FIELD DEVICE

(75) Inventor: Ralf HUCK, Grosskrotzenburg (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/269,437

(22) Filed: Nov. 12, 2008

(30) Foreign Application Priority Data
Nov. 14, 2007 (DE) 10 2007 054 662.0

(51) Int. Cl. G05B 15/00; H04B 1/38

(52) U.S. Cl. 700/75; 455/73

(57) ABSTRACT

A field device of a distributed automation system is disclosed for controlling and monitoring technical processes. In order to include the field device in an installation management system, an exemplary field device has an associated wireless adapter. The wireless adapter is equipped with an identification feature which comprises the identification feature of the associated field device and a generic supplement.

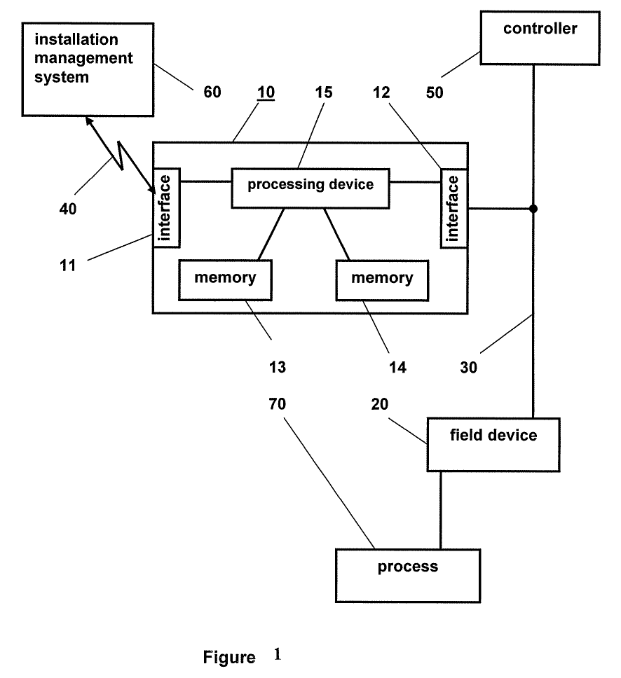

### RELATED APPLICATION

This application claims priority under 35 U.S.C. §119 to German Patent Application No. DE 10 2007 054 662.0 filed in Germany on Nov. 14, 2007, the entire content of which is hereby incorporated by reference in its entirety.

### TECHNICAL FIELD

The disclosure relates to a field device of a distributed automation system for controlling and monitoring technical processes.

### BACKGROUND INFORMATION

In complex and/or physically extended process installations, a multiplicity of such field devices is installed in order to control the technical process in the process installation. These include measured-value sensors for physical variables such as pressure, temperature, flow rate, concentration and the like, as well as actuated elements, so-called actuators, for operation of the valves, flaps, feed means and the like.

Field devices such as these are a component of control loops and are connected for communication purposes via communication networks to a central open-loop and closed-loop control device. The field devices can be controlled locally and remotely for configuration, setting up and/or diagnosis.

The communication networks are used to interchange measurement data in automation. Cable-based and wireless networks are known. Cable-based networks require a large amount of installation and wiring complexity. Wireless networks, in contrast, are simple to set up with considerably less installation complexity.

As a result of the network structure, all the field devices are galvanically connected to the fieldbus network. A disturbance which affects only one subscriber thus affects the entire network. It is therefore likewise no longer possible for all the other subscribers to transmit data, or else there is at least considerable disturbance to this. In the extreme, the disturbance can lead to considerable, irreparable damage. Typical disturbances in process installations include in particular short circuits, line interruptions, EMC interference and lightning strike.

Furthermore, deliberate actions by the operator of an automation component can also be regarded as disturbances. These actions are required, for example, for maintenance purposes and in this case always represent a risk to continuous operation of an installation, as is required in the process industry. To a particular extent, this includes extensions to the functional scope of an automation installation, such as those required for integration of installation management systems.

Installation management systems such as these are used to gather and preprocess information relating to the state of the peripheral appliances. The central control of an automation installation is designed primarily for the processing of process values, and, furthermore, is not suitable for dealing with and providing such information from peripheral appliances which are connected in an analog form via a 0/4 . . . 20 mA interface. This relates in the same way to process controls with analog information transmission and superordinate HART communication, in which the input/output assemblies for connection of the peripheral appliances are not compatible with HART communication, as well as a fieldbus system without acyclic services. At these process controls, the information which is required for installation management is not available in the central control, and is therefore not accessible to a superordinate installation management system.

DE 10 2007 003 196 A1 discloses the use of so-called wireless adapters for provision of the installation management information of HART-compatible appliances. These are looped in series into the 4 . . . 20 mA circuit, in order to tap off desired HART information from the field device.

The wireless adapter can now be used to send the HART information tapped off in this way via a radio network to a gateway. In this constellation, the installation management information can be supplied via radio to a central installation management system. The analog data is still provided via the 4 . . . 20 mA interface, and can be supplied to the central control on conventional, cable-based transmission paths.

The design and method of operation of such wireless adapters are described in the specifications of the HART Foundation.

Retrospective installation of the wireless adapter described here is associated with large amounts of effort for the user, since the adapter must be represented as a logically autonomous appliance unit with its own address.

If all the field devices are each equipped with a wireless adapter, the central engineering is loaded with twice the number of appliances by the addition of new appliances, specifically the adapters.

The change in the installation topology resulting from a new appliance with a new address often makes it necessary to switch the installation off, since many process control systems do not allow such reconfiguration during operation.

Furthermore, the change to the installation topology requires complete rebuilding of the documentation of the central engineering since the autonomous appliances must be represented appropriately.

In this context further efforts are involved as a result of the setting up and servicing of a logically independent appliance unit in the field, as well as the documentation of a logically independent field device in the field device documentation.

### SUMMARY

A field device is disclosed with which a wireless adapter can be associated without any change to the installation topology.

A field device having a wireless adapter for wireless communication is disclosed, with the adapter being distinguished by the following features: a first interface for wireless communication via a wireless communication network, for the first interface, a generic address which is composed of parts of the address of the subordinate field device and specific extensions for wireless communication, a second interface for cable-based point-to-point communication between the adapter and the analog field device, a first local memory for storage/buffering the time-critical appliance data from the point-to-point communication via the second interface, a second local memory for the data which is required to set up the wireless network, a processing device for parallel communication via the first and the second interface, a processing device for complete representation of the analog field device, which is subordinate thereto, in the wireless network with time-critical data being provided directly from the buffer and non-time-critical data being called up via a transparent mode from the subordinate field device via the second interface, and a generic appliance description of the functional features of the adapter.

A method for setting up a field device having a wireless adapter is disclosed, comprising the following steps: autonomous setting up of the point-to-point communication with the field device, reading the address of the subordinate field device and storage of the composed, generic address, filling the second local memory with data which is required for wireless communication, filling the first local memory with time-critical data from the point-to-point communication, and setting up the wireless communication.

In another aspect, a field device of a distributed automation system is disclosed for controlling and monitoring technical processes. Such a field device comprises a wireless adapter for wireless communication; and an identifier associated with the wireless adapter identifying the field device and a generic supplement in order to include the field device in an installation management system.

### BRIEF DESCRIPTION OF THE DRAWING

The single FIGURE shows a wireless adapter associated with an exemplary field device of a distributed automation system for controlling and monitoring technical processes in an installation management system.

### DETAILED DESCRIPTION

The disclosure is based on a field device which, in a cable-based communication network, can be distinguished without any doubt by means of a unique identification feature from other devices in the same communication network.

The essence of the disclosure is to equip the wireless adapter with an identification feature which comprises the identification feature of the associated field device and a generic supplement. This makes it possible to administratively distinguish the wireless adapter from its field device, with the wireless adapter representing the field device associated with it in the cable-based communication network, transparently at the same address.

With reference to the single FIGURE, and against the background of a field device associated with it in the cable-based communication network, transparently at the same address.

With reference to the single FIGURE, and against the background of a field device 20 of a distributed automation system for controlling and monitoring technical processes 70, a wireless adapter 10 is associated with this field device 20 in order to include this field device 20 in an installation management system 60.

The field device 10 is connected point-to-point via a cable-based communication network 30 to a central control device 50 for controlling and monitoring a technical process 70. In this case, in the cable-based communication network 30, the field device 10 can be distinguished without any doubt by a unique identification feature from other devices in the same communication network 30.

The adapter 10 has a first interface 11 for wireless communication via a wireless communication network 40 and a second interface 12 for cable-based point-to-point communication between the adapter 10 and the analog field device 20.

The wireless adapter 10 is connected via the wireless communication network 40 to an installation management system 60 in which information is gathered relating to the state of the peripheral appliances, in particular the field device 20.

The wireless adapter 10 is connected via its second interface 12 to the cable-based communication network 30, between the field device 20 and the central control 50.

Furthermore, the wireless adapter 10 has a first local memory 13 for storage/buffering of the time-critical appliance data from the point-to-point communication via the second interface 12, and a second local memory 14 for the data required to set up the wireless network 40. Furthermore, the wireless adapter 10 is equipped with a processing device 15, which is intended for parallel communication via the first and the second interface 11 and 12 and for complete representation of the analog field device 20 which is subordinate thereto, in the wireless network 40. In this case, time-critical data is provided directly from the buffer, and non-time-critical data is called up via a transparent mode from the subordinate field device 20 via the second interface 12. Finally, provision is made for the wireless adapter 10 to have a generic appliance description of its functional features.

In the wireless network 40, the wireless adapter 10 is characterized by a unique identification feature which is composed of parts of the address of the subordinate field device 20 and specific extensions for wireless communications.

During the initialization of the wireless adapter 10, the address of the subordinate field device 20 is determined first of all. This is done by setting up a point-to-point communication with the field device 20, and by reading the address of the subordinate field device 20. The address of the subordinate field device 20 has the specific extensions for wireless communication added to it, and is stored as a generic identification feature of the wireless adapter 10.

Furthermore, the second local memory 14 is filled with data that is required for wireless communication, and the time-critical data from the point-to-point communication is stored in the first local memory 13.

The wireless communication to the installation management system 60 is then set up. The data is transferred from the second local memory via the wireless communication network 40.

In the cable-based communication network 30, the wireless adapter 10 represents the subordinate field device 10 to the control 50, with the time-critical appliance data from the point-to-point communication being provided directly from the buffer.

For complete representation of the analog field device 20 which is subordinate to it in the wireless network 40, time-critical data is provided directly from the buffer, and non-time-critical data is called up via a transparent mode from the subordinate field device 20 via the second interface 12.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

List of Reference Symbols

| | |
|---|---|
| 10 | Wireless adapter |
| 11 | First interface |
| 12 | Second interface |
| 13, 14 | Memory |
| 15 | Processing device |
| 20 | Field device |
| 30 | Cable-based communication network |
| 40 | Wireless communication network |
| 50 | Controller |
| 60 | Installation management system |
| 70 | Process |

What is claimed is:

1. A field device having a wireless adapter for wireless communication, the wireless adapter comprising:
a first interface for wireless communication via a wireless communication network;
for the first interface, a generic address which is composed of parts of the address of the subordinate field device and specific extensions for wireless communication;
a second interface for cable-based point-to-point communication between the adapter and the analog field device;
a first local memory for storage/buffering the time-critical appliance data from the point-to-point communication via the second interface;
a second local memory for the data which is required to set up the wireless network;
a processing device for parallel communication via the first and the second interface;
a processing device for complete representation of the analog field device, which is subordinate thereto, in the wireless network with time-critical data being provided directly from the buffer and non-time-critical data being called up via a transparent mode from the subordinate field device via the second interface; and
a generic appliance description of the functional features of the adapter.

2. A method for setting up a field device having a wireless adapter, comprising the following steps:
autonomous setting up of the point-to-point communication with the field device;
reading the address of the subordinate field device and storage of the composed, generic address;
filling the second local memory with data which is required for wireless communication;
filling the first local memory with time-critical data from the point-to-point communication; and
setting up the wireless communication.

3. A field device of a distributed automation system for controlling and monitoring technical processes, comprising:
a wireless adapter for wireless communication; and
an identifier associated with the wireless adapter identifying the field device and a generic supplement in order to include the field device in an installation management system.

4. The field device according to claim 3, wherein the field device of a distributed automation system is for controlling and monitoring technical processes.
